(19) United States
(12) Patent Application Publication
(10) Pub. No.: US 2026/0058563 A1
(43) Pub. Date: Feb. 26, 2026

(54) High Efficiency Cascaded MOSFET Flyback Converter for Generating the Power Supply Voltage for Power Converter Integrated Circuits

(71) Applicant: Renesas Design (UK) Limited, Bourne End (GB)

(72) Inventors: Kai Wan, San Jose, CA (US); Henry Jun, Campbell, CA (US); Jun Zheng, Shenzhen (CN); Guang Feng, Campbell, CA (US)

(21) Appl. No.: 18/812,311

(22) Filed: Aug. 22, 2024

(51) Int. Cl. H02M 3/335

(52) U.S. Cl. CPC H02M 3/33523

(57) ABSTRACT

A system is provided that includes a diode bridge for rectifying an AC input voltage. A main switching power converter converts a rectified input voltage from the diode bridge into an output voltage. A flyback converter is coupled either to a pre-bridge node or a post-bridge node to receive an input voltage that is converted into a power supply voltage for a controller integrated circuit. The controller integrated circuit regulates both the output voltage and the power supply voltage.

### TECHNICAL FIELD

This application relates to switching power converters, and more particularly to a to a cascaded MOSFET flyback converter for generating the power supply voltage for power converter integrated circuits.

### BACKGROUND

In a switching power converter, one or more controller integrated circuits control the cycling of a power switch transistor to regulate an output voltage. These controller integrated circuits require their own power supply voltage to implement the control of a power switch transistor. The switching power converter thus requires a power generation circuit to generate the power supply voltage. There are several challenges with respect to the design of a suitable power generation circuit. For example, the power generation circuit must regulate the power supply voltage to remain within an operating range to ensure the integrated circuit functions properly. In addition, the power generation circuit should have high efficiency, especially in applications that require minimal loss under very low load conditions. The power generation circuit should satisfy these requirements at low cost and within a low form factor. Moreover, the power generation circuit should operate without audible noise across its entire operating range and maintain high reliability within the customer's specified environmental temperature conditions.

### SUMMARY

In accordance with an aspect of the disclosure, a flyback converter for generating a power supply voltage of a controller integrated circuit for a main switching power converter is provided that includes: a transformer including a primary winding and a secondary winding; a first transistor having a drain coupled to the primary winding; a power supply voltage capacitor having a positive terminal coupled to the secondary winding and having a negative terminal coupled to ground; and a second transistor having a drain coupled to a source of the first transistor and having a drain coupled to ground, wherein the controller integrated circuit includes a power supply voltage terminal coupled to the drain of the first transistor and to the positive terminal of the power supply voltage capacitor.

In accordance with another aspect of the disclosure, a system is provided that includes: a diode bridge including a pair of input terminals and a pair of output terminals; a main switching power converter coupled to the pair of output terminals and configured to convert a rectified input voltage into an output voltage; a controller integrated circuit configured to provide a modulation signal to the main switching power converter to regulate the output voltage; a first diode having an anode coupled to a positive input terminal from the pair of input terminals; a second diode having an anode coupled to a negative input terminal from the pair of input terminals; and a flyback converter including a transformer having a primary winding coupled to a cathode of the first diode and to a cathode of the second diode and having a secondary winding coupled to a power supply voltage capacitor configured to store a power supply voltage for the controller integrated circuit.

In accordance with yet another aspect of the disclosure, a system is provided that includes: a diode bridge including a pair of input terminals and a pair of output terminals; an input voltage capacitor coupled between the pair of output terminals; a main switching power converter coupled to the pair of output terminals and configured to convert a rectified input voltage stored by the input voltage capacitor into an output voltage; a controller integrated circuit configured to provide a modulation signal to the main switching power converter to regulate the output voltage; and a flyback converter including a transformer having a primary winding having an input terminal coupled to a positive output terminal from the pair of output terminals and having a secondary winding coupled to a power supply voltage capacitor configured to store a power supply voltage for the controller integrated circuit.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a system including a main switching power converter controlled by a controller whose power supply voltage is generated by a VCC charging circuit having a post-bridge coupling in accordance with an aspect of the disclosure.

FIG. 2 illustrates a system including a main switching power converter controlled by a controller whose power supply voltage is generated by a VCC charging circuit having a pre-bridge coupling in accordance with an aspect of the disclosure.

FIG. 3 illustrates the post-bridge coupling of the system of FIG. 1 in more detail in accordance with an aspect of the disclosure.

FIG. 4 illustrates the pre-bridge coupling of the system of FIG. 2 in more detail in accordance with an aspect of the disclosure.

FIG. 5A illustrates the start-up current flow through a system having a pre-bridge coupling in accordance with an aspect of the disclosure.

FIG. 5B illustrates the primary winding current flow during normal operation of a system having a pre-bridge coupling in accordance with an aspect of the disclosure.

FIG. 5C illustrates the secondary winding current flow during normal operation of a system having a pre-bridge coupling in accordance with an aspect of the disclosure.

FIG. 6 illustrates some waveforms for the systems of FIGS. 5B and 5C.

FIG. 7 illustrates the X capacitor discharge current flow through a system having a pre-bridge coupling in accordance with an aspect of the disclosure.

FIG. 8 illustrates a system having a post-bridge coupling in accordance with an aspect of the disclosure.

FIG. 9 illustrates the rectified AC line voltage and the PWM_Vcc modulation signal for a system including both a valley-stop mode and a peak-stop mode in accordance with an aspect of the disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Given the stringent requirements for a suitable IC power supply voltage (VCC) generation circuit, it is thus not surprising that conventional VCC charging circuits have a number of drawbacks. For example, it is conventional for a VCC charging circuit in a flyback converter to include a startup metal-oxide semiconductor field-effect transistor (MOSFET) that couples to the rectified input voltage rail. During power-up of the flyback converter, the startup MOSFET conducts to generate the power supply voltage for the flyback converter integrated circuit (IC) controller. As the flyback converter transitions to normal operation, an auxiliary winding begins to produce voltage. Once this voltage is sufficient, the startup MOSFET is bypassed and the auxiliary winding functions as part of the VCC charging circuit to generate the IC power supply voltage. But the voltage produced by the auxiliary winding is directly proportional to the output voltage of the flyback converter as determined by the transformer turns ratio. Should the flyback converter have a wide output voltage, the IC power supply voltage may then be forced outside of its operating range. To keep the IC power supply voltage within the operating range, the VCC charging circuit may include a low-dropout regulator (LDO) that steps down the auxiliary winding voltage to produce the IC power supply voltage. In this fashion, the IC power supply voltage is kept within the desired operating range despite the output voltage being high. However, the resulting incorporation of an LDO in the VCC charging circuit increased costs and circuit size while also reducing efficiency.

The auxiliary winding also affects the coupling between the flyback transformer's primary and secondary windings and increases the leakage inductance. As a result, the inclusion of the auxiliary winding reduces the flyback converter efficiency and increases oscillations and voltage stress on its components. Moreover, since the IC power supply voltage depends on the auxiliary winding voltage that in turn depends on the output voltage, the operation of the VCC charging circuit depends on the main circuit output voltage. This dependence on the output voltage significantly limits the potential for efficiency optimization in the IC power supply voltage generation. Finally, the auxiliary winding increases costs and adds to the complexity of the transformer design.

To address these issues, a VCC charging circuit is provided that generates an IC power supply voltage without the need of an auxiliary winding. The VCC charging circuit generates a power supply voltage for a controller IC. The controller IC may then control the cycling of one or more power switch transistors in a switching power converter stage. The switching power converter stage (which is also denoted herein as a main circuit) may have any suitable topology including flyback, buck, boost, buck/boost and other switching power converter architectures. The switching power converter stage converts a rectified input voltage (or rectified input current) from a diode bridge that rectifies an alternating current (AC) input voltage. The controller IC modulates the cycling of the power switch(es) to produce a desired output voltage (or output current). In the following discussion, it will be assumed that the controller IC modulates the power switch cycling using a pulse width modulation (PWM) but it will be appreciated that a pulse frequency modulation (PFM) or a pulse train modulation may be used in alternative implementations.

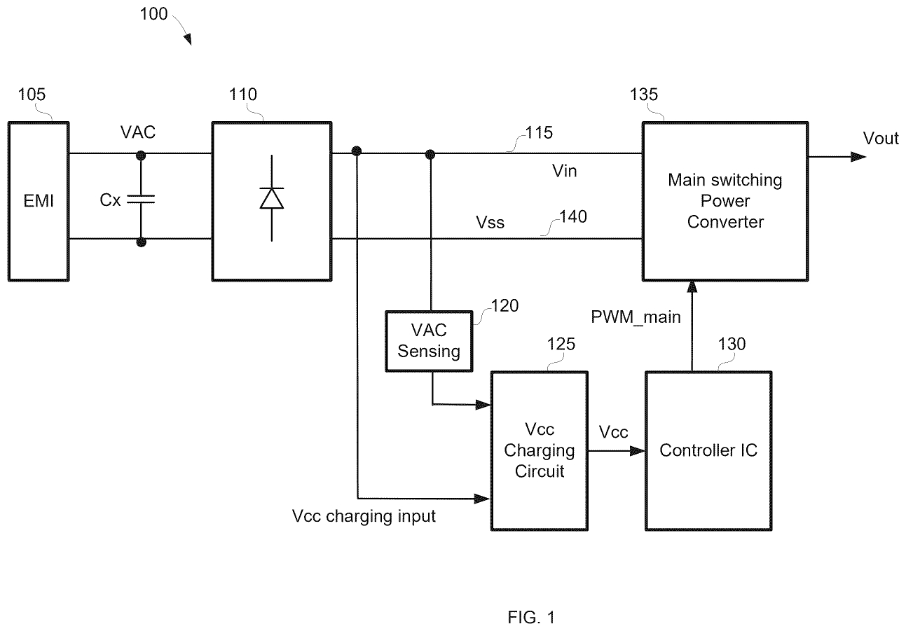

To produce the IC power supply voltage, the VCC charging circuit disclosed herein uses a flyback topology that is separate from whatever topology is used in the main circuit. The VCC charging circuit thus includes a transformer having a primary winding and a secondary winding. The primary winding couples to an input voltage node. The input voltage node may be located pre-bridge or post-bridge with respect to the diode bridge that also powers the main circuit. Both the pre-bridge and the post-bridge connection points for the input voltage node have their advantages and disadvantages that will be discussed further herein. An example system 100 with a VCC charging circuit 125 is shown in FIG. 1 in which the VCC charging input voltage is taken post-bridge from a diode bridge 110. The VCC charging circuit 125 provides a power supply voltage (VCC) to a controller IC 130 that controls the cycling of one or more power switches in a main switching power converter 135 through a pulse width modulation control signal (PWM_main) to regulate an output voltage (Vout). To provide a VCC charging input voltage to the VCC charging circuit 125, the diode bridge 110 rectifies an AC input voltage (VAC) that is filtered by an electromagnetic interference filter (EMI) 105 to prevent switching noise from a main circuit 135 from affecting the AC input voltage. The diode bridge 110 may be charged to a relatively high voltage by the AC input voltage. Should the main switching power converter 135 be disconnected from the AC input voltage or should the AC input voltage suffer a brown-out condition, the charge stored on an X-capacitor Cx is dissipated as further described herein.

As discussed earlier, the main switching power converter 135 may be a flyback converter, a buck converter, a buck/boost converter, or some other suitable switching power converter. The main switching power converter 135 receives a rectified input voltage Vin on a voltage rail 115 that is charged by the diode bridge 110. The main switching power converter 135 also receives ground (Vss) from a ground rail 140 that couples between the diode bridge 110 and the main circuit 135. The VCC charging circuit 125 also couples to the voltage rail 115 to receive a VCC charging input voltage (a ground connection to the ground rail 140 for the VCC charging circuit 125 is not shown for illustration clarity). It may thus be appreciated that the input voltage node for the VCC charging circuit 125 is the voltage rail 115, which is a post-bridge coupling. The VCC charging circuit 125 also couples to the voltage rail 115 to sense the AC input voltage VAC through a VAC sensing circuit 120. Such a post-bridge topology or coupling to both receive an input voltage and to sense the AC input voltage has a number of advantages as compared to a pre-bridge coupling. For example, the VCC charging circuit 125 may couple to the voltage rail 115 directly without the need for additional high voltage diodes, which lowers manufacturing costs and reduces the system size. In addition, sampling on the DC side (post-bridge side) of the diode bridge 110 facilitates the implementation of power factor correction (PFC) in the VCC charging circuit 125, which enhances the overall efficiency and stability of the system 100. Effective PFC reduces harmonic components in the input current conducted from the diode bridge 110 to the VCC charging circuit 125, thereby minimizing pollution to the AC mains (not illustrated) providing the AC input voltage. Moreover, a post-bridge coupling allows the VCC charging circuit 125 to bypass switching frequency noise as will be explained further herein. A pre-bridge implementation will now be discussed.

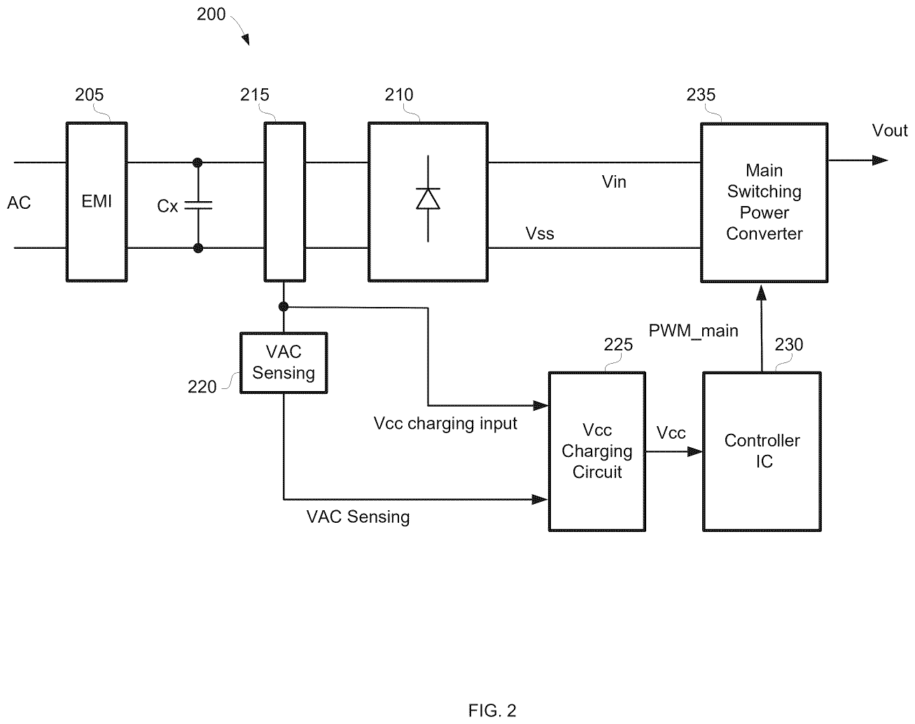

An example system 200 with a VCC charging circuit 225 is shown in FIG. 2 in which the VCC charging input voltage is taken before a diode bridge 210. As discussed analogously for the system 100, the diode bridge 210 in the system 200 rectifies an AC input voltage (VAC) that is filtered by an electromagnetic interference filter (EMI) 205 to prevent switching noise from a main switching power converter 235 from affecting the AC input voltage. The X capacitor Cx in system 100 functions as it does for system 100 with respect to reducing EMI from the system 200 from polluting the AC mains. Since the coupling to the VCC charging circuit 225 is pre-bridge, the coupling is directly exposed to the relatively high swings of the AC input voltage. Thus, the coupling occurs through high-voltage diodes that are shown in FIG. 2 as a coupling circuit 215 for illustration brevity. The coupling circuit 215 provides the VCC charging input voltage to the VCC charging circuit 225. In addition, the coupling circuit 215 couples to the VCC charging circuit 225 through a VAC sensing circuit 220 so that the VCC charging circuit 225 may sense the AC input voltage VAC. The VCC charging circuit 225 powers a controller IC 230 with a power supply voltage (VCC). Being powered, the controller IC 230 may then control the cycling of one or more power switches in the main switching power converter 235 through a pulse width modulation control signal (PWM_main) to regulate an output voltage (Vout).

The pre-bridge coupling through the coupling circuit 215 has a number of advantages for the system 200. For example, the system 200 may more quickly discharge the X capacitor Cx as compared to the post-bridge coupling of system 100. In addition, pre-bridge sampling of the AC input voltage allows the VCC charging circuit 225 to more accurately measure the AC input voltage as this measurement is direct whereas system 100 must estimate the AC input voltage after rectification by the diode bridge 110. The post-bridge measurement in the system 100 after rectification of the AC input voltage loses some information about the original AC frequency, amplitude, and phase. In contrast, the pre-bridge sensing of the AC input voltage in the system 200 is unaltered so that the VCC charging circuit 225 may accurately and directly measure the amplitude, frequency, and phase of the AC input voltage. In addition, the pre-bridge sampling of the AC input voltage enables the VCC charging circuit 225 to detect instantaneous changes in the AC input voltage, which is critical for functions such as power factor correction. As a result, the pre-bridge coupling to the VCC charging circuit 225 enables better protection of the system 200. Moreover, the more accurate sensing of the AC input voltage ensures that the power supply voltage VCC is better regulated despite variations in the AC input voltage because the VCC charging circuit 225 may respond more quickly and accurately to the variations, which also allows for earlier fault detection. Some example pre-bridge and post-bridge couplings will now be discussed in more detail.

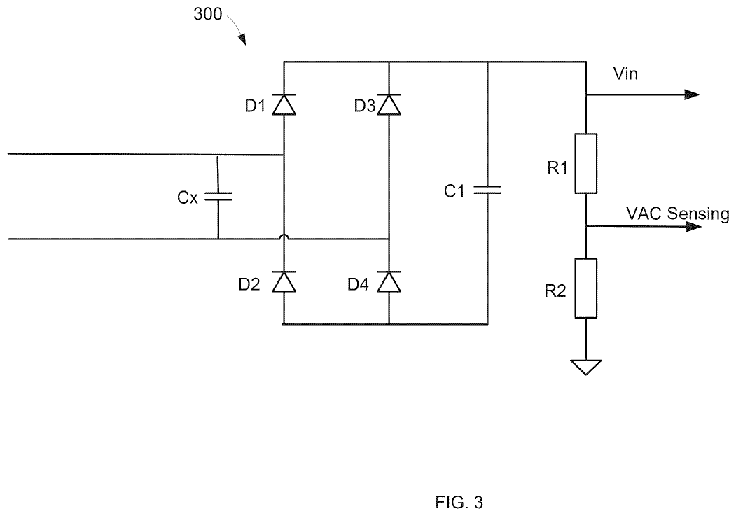

An example post-bridge system 300 is shown partly in FIG. 3. For illustration brevity, the EMI filter and the main circuit are not shown. The diode bridge is implemented through diodes D1, D2, D3, and D4 with the AC input voltage being received across the X capacitor Cx that couples between a pair of input terminals to the diode bridge. A post-bridge capacitor C1 that couples across a pair of output terminals of the diode bridge helps smooth the rectified input voltage Vin that functions as the rectified input voltage to a transformer (not illustrated). The rectified input voltage Vin is also the input voltage for the main switching power converter (not illustrated). To receive the rectified input voltage Vin, the VCC charging circuit (not illustrated) couples to a positive terminal of the post-bridge capacitor C1. The VAC sensing circuit is implemented through a resistive voltage divider such as formed by a serial pair of resistors R1 and R2 that couple between the positive terminal of the post-bridge capacitor C1 and ground. To sense the AC input voltage (VAC sensing), the VCC charging circuit (not illustrated) couples to a node between the resistors R1 and R2.

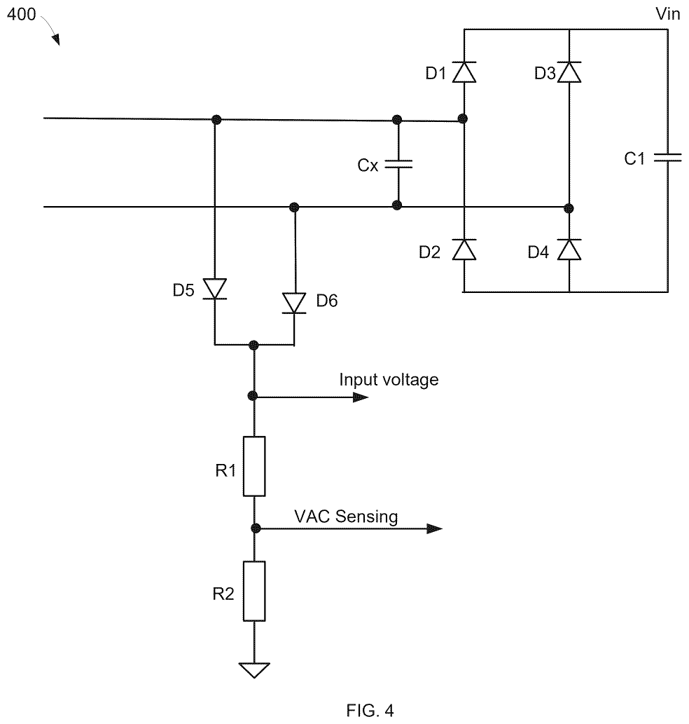

An example pre-bridge system 400 is shown partly in FIG. 4. For illustration brevity, the EMI filter and the main switching power converter are not shown. As discussed for system 300, the diode bridge in system 400 is implemented through diodes D1, D2, D3, and D4 with the AC input voltage being received across the X capacitor Cx. A post-bridge capacitor C1 helps smooth a rectified input voltage Vin that drives the main switching power converter. Since the coupling to a VCC charging circuit (not illustrated) is pre-bridge, the coupling occurs through a pair of high-voltage diodes D5 and D6 that each have an anode coupled to respective terminals of the X capacitor Cx. The cathodes of diodes D5 and D6 form an input node to the VCC charging circuit to provide the VCC charging input voltage. In addition, the input node formed by the cathodes of the diodes D5 and D5 couples through a VCC sensing circuit implemented through a resistive voltage divider such as formed by the serial pair of resistors R1 and R2 that couple between the input node and ground. To sense the AC input voltage (VAC sensing), the VCC charging circuit couples to a node between the resistors R1 and R2.

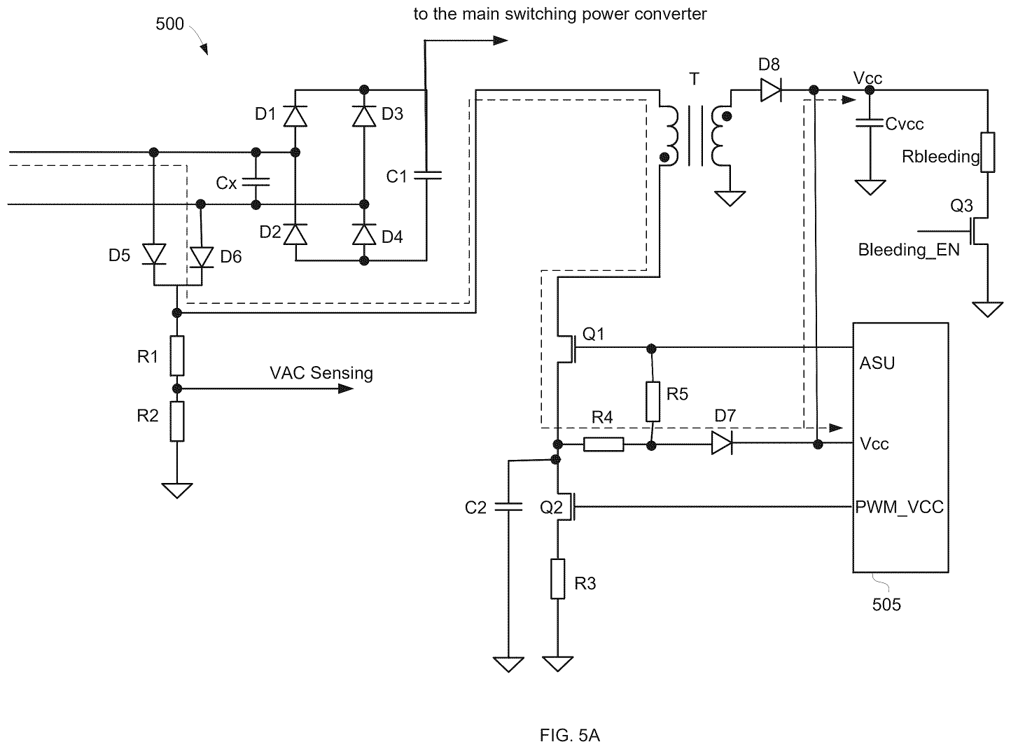

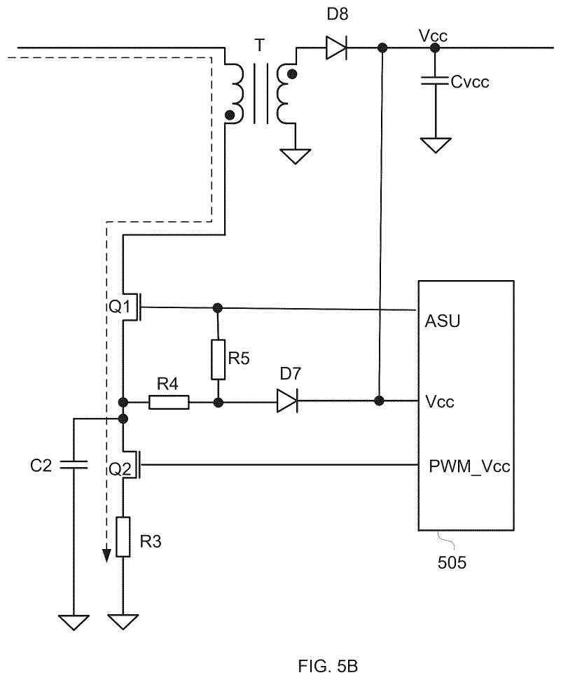

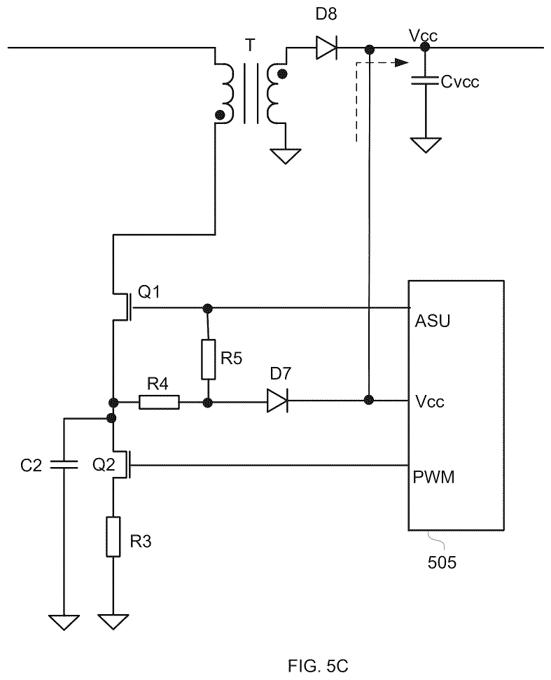

The following discussion will now address the operation of pre-bridge and post-bridge implementations in more detail. For example, the start-up behavior of a pre-bridge system 500 is shown in FIG. 5A. The X capacitor Cx, the high voltage diodes D5 and D6, the resistors R1 and R2, the diode bridge diodes D1, D2, D3, and D4, and the post-bridge capacitor C1 are arranged as discussed for the pre-bridge system 400. The positive terminal of the post-bridge capacitor C1 provides a rectified input voltage to the main switching power converter (not illustrated). The cathodes of the diodes D5 and D6 couple to an input terminal of a primary winding of a transformer T. An output terminal of the primary winding couples to ground through a pair of MOSFETS including a depletion-mode n-type metal-oxide semiconductor (NMOS) transistor Q1 having a drain coupled to the output terminal of the primary winding. The pair of MOSFETs also includes an enhancement-mode NMOS transistor Q2 having a drain coupled to a source of the transistor Q1. The transistors Q1 and Q2 may be deemed to be in cascade since the output source current from the transistor Q1 forms the input current to the transistor Q2.

A controller IC 505 controls the cycling of one or more power switches in the main switching power converter to regulate the output voltage produced by the main switching power converter. At start-up, the controller IC 505 has no power and cannot switch on the transistor Q2. But since the transistor Q1 is a depletion-mode transistor, it will conduct at start-up even though the controller IC 505 is initially without power. A charging current will thus flow from the cathodes of the diodes D5 and D5 through the primary winding and through the transistor Q1 at start-up. The source of the transistor Q1 couples through a resistor R4 and a diode D7 to a VCC terminal of the controller IC 505. In particular, the anode of the diode D7 couples to the resistor R4 whereas its cathode couples to the VCC terminal. In addition, the cathode of the diode D7 couples to a positive terminal of a VCC capacitor (CVcc) having a negative terminal coupled to ground. A secondary winding of the transformer couples to the positive terminal of the capacitor CVcc through a diode D8. The positive terminal of the VCC capacitor CVcc also couples to ground through a bleeder resistor Rbleeding and a bleeder transistor Q3 whose operation will be discussed later.

Since the transistor Q1 is conducting at start-up, the start-up charging current conducts from the source of the transistor Q1 through the resistor R4 and through the diode D7 to begin charging the VCC capacitor with the power supply voltage Vcc. To control the operation of the transistor Q1, an active start-up (ASU) terminal of the controller IC 505 couples to a gate of the transistor Q1. To prevent the gate of the transistor Q1 from floating at start-up, a resistor R5 couples from the anode of the diode D7 to the ASU terminal and to the gate of the transistor Q1. Resistor R5 may have a relatively high resistance so that it does not conduct significant current but instead functions to prevent the gate of the transistor Q1 from having an undefined voltage at start-up. With the charging current charging the capacitor CVcc, the power supply voltage Vcc will begin to rise. The charging current at start-up is determined by the threshold voltage of transistor Q1 and the resistance of resistor R4. Once the power supply voltage VCC as stored on the VCC capacitor reaches an operating level to power the controller IC 505, the start-up phase ends and the controller IC 505 may begin modulating the cycling of the transistor Q2 by driving the gate of the transistor Q2 with a pulse width modulation signal PWM_Vcc. In system 500, the VCC charging circuit would thus be formed by the transformer T, transistors Q1, Q2 and Q3, resistors R3, R4, R5 and Rbleeding, diodes D7 and D8, and the capacitors C2 and CVcc.

The charging current flow when the controller IC 505 asserts the signal PWM_Vcc to switch on the transistor Q2 is shown in FIG. 5B. The charging current now conducts through the primary winding and through the channel of the transistor Q1 into the drain of the transistor Q2 and from the source of the transistor Q2 into ground. To allow the controller IC 505 to monitor the charging current, the source of the transistor Q2 may couple to ground through a sense resistor such as a resistor R3. The controller IC 505 may thus include a terminal (not illustrated) that couples to a node between the sense resistor R3 and the source of the transistor Q2. By monitoring the sense resistor voltage, the controller IC 505 may cycle off the transistor Q2 once a desired peak charging current has been reached to regulate the power supply voltage Vcc.

The charging current flow when the controller IC 505 de-asserts the signal PWM_Vcc to switch off the transistor Q2 is shown in FIG. 5C. Prior to the switching off of the transistor Q1, the transformer T stored magnetic energy from the conduction of the charging current through the primary winding. With the switching off of the transistor Q1, the stored magnetic energy drives a secondary winding current. To prevent the secondary winding current from conducting while the transistor Q1 is on, the secondary winding current is rectified through the diode D8, which has an anode coupled to the secondary winding and a cathode coupled to the positive terminal of the VCC capacitor CVcc. Alternatively, the secondary winding current may be rectified through a synchronous rectifier (SR) switch transistor (not illustrated) that would be controlled by the controller IC 505 accordingly. With the transistor Q2 switched off, the secondary winding current conducts as an output current through the diode D8 to charge the capacitor CVcc with the power supply voltage Vcc. The controller IC 505 may use any suitable control methodology to regulate the cycling of the transistor Q2 including a peak current control or a constant on-time control of the transistor Q2.

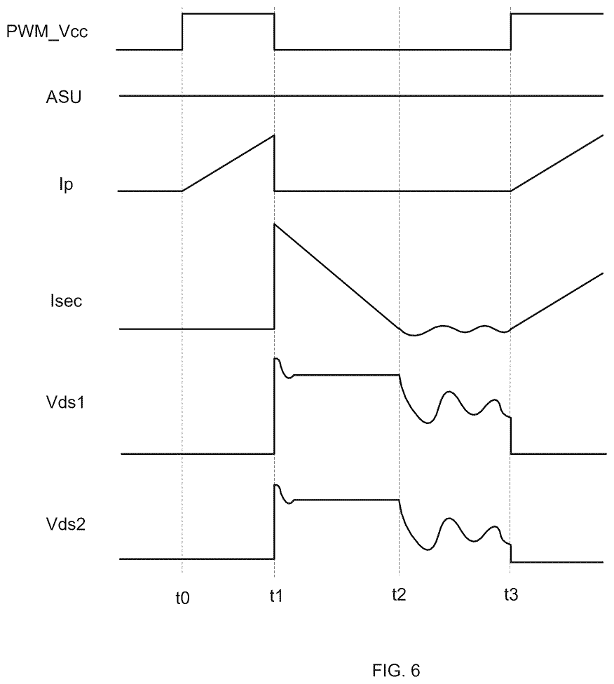

Some operating waveforms for the system 500 are shown in FIG. 6. At a time to, the controller IC asserts the PWM_Vcc modulation signal to switch on the transistor Q2. A primary winding current (Ip) begins ramping up until it reaches a peak current at a time t2.

While the primary winding current conducts, a secondary winding current (Isec) does not conduct due to the rectification by the secondary-side diode D8. At a time t1, the controller IC de-asserts the PWM_Vcc modulation signal to switch off the transistor Q2. The primary winding current thus drops to zero while the secondary winding jumps high and begins to ramp down. At a time t2, the transformer reset period ends with the secondary winding current ramping to zero. The drain-to-source voltage Vds1 of the transistor Q1 and the drain-to-source voltage of the transistor Q2 both begin resonantly oscillating until another on-time for the transistor Q1 begins at a time t3. During the cycling of the transistor Q2, the ASU signal is kept de-asserted so that the transistor Q1 will conduct when the transistor Q2 is switched on. When the transistor Q2 switches off, the source voltage of the transistor Q1 rises, which makes the gate-to-source voltage of the transistor Q1 lower than its threshold voltage to also switch off the transistor Q1. With both the transistors Q1 and Q2 off, they block the relatively high input voltage together as a capacitive voltage divider. In some implementations, the output capacitance of the transistor Q2 may be sufficiently higher than the output capacitance of the transistor Q1 such that the transistor Q1 bears the bulk of the input voltage while the transistors Q1 and Q2 are off. Referring again to FIG. 5A, a capacitor C2 may couple between the drain of the transistor Q2 and ground to ensure that the drain-to-source voltage of the transistor Q2 remains relatively low. In this fashion, the transistor Q2 may be integrated into the controller IC to lower manufacturing costs and simplify the transistor control since only the transistor Q1 would need to be robust to high levels of drain-to-source voltage. It will thus be appreciated that the transistor Q1 is shown separately from the controller IC merely for illustration clarity. The capacitor C2 may be eliminated if the output capacitance of the transistor Q2 is sufficiently higher than the output capacitance of the transistor Q1.

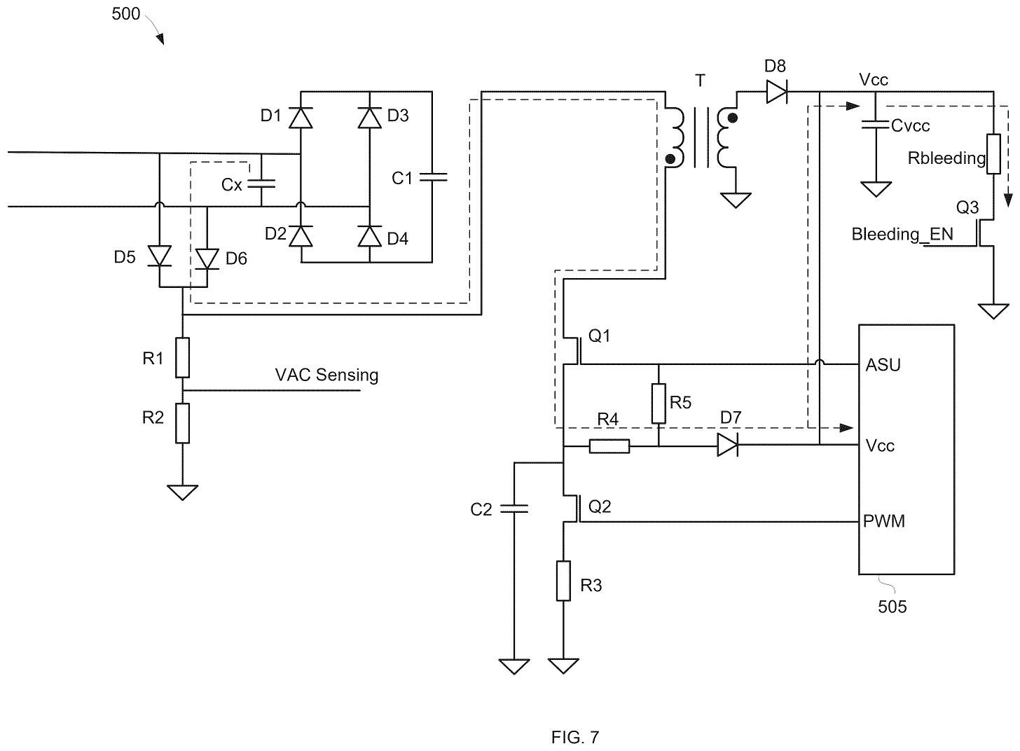

Referring now to FIG. 7, the discharging of the X capacitor in the system 500 will now be discussed. This discharge involves a bleeder transistor having a source coupled to ground and a drain coupled to the positive terminal of the VCC capacitor through a bleeder resistor Rbleeding. Note that a discharging current path from the X capacitor Cx in the system 500 is largely analogous to the current path during start-up. This discharging current occurs if the system is disconnected from the AC mains or in response to a fault condition such as failure (e.g., brownout) of the AC mains. To control the discharge, the controller IC 505 switches on the bleeder transistor Q3 by asserting a bleeding enable signal (Bleeding_EN) that charges the gate of the bleeder transistor Q3 so that the X capacitor Cx may discharge through the diode D5 (or diode D6) and then through the primary winding, the transistor Q1, resistor R4, diode D7, the bleeder resistor Rbleeding, and the bleeder transistor Q3 into ground. This discharge will occur faster through the pre-bridge coupling as compared to a post-bridge coupling. The discharging current magnitude is determined by the threshold voltage of the transistor Q1 and the resistance of the resistor R4.

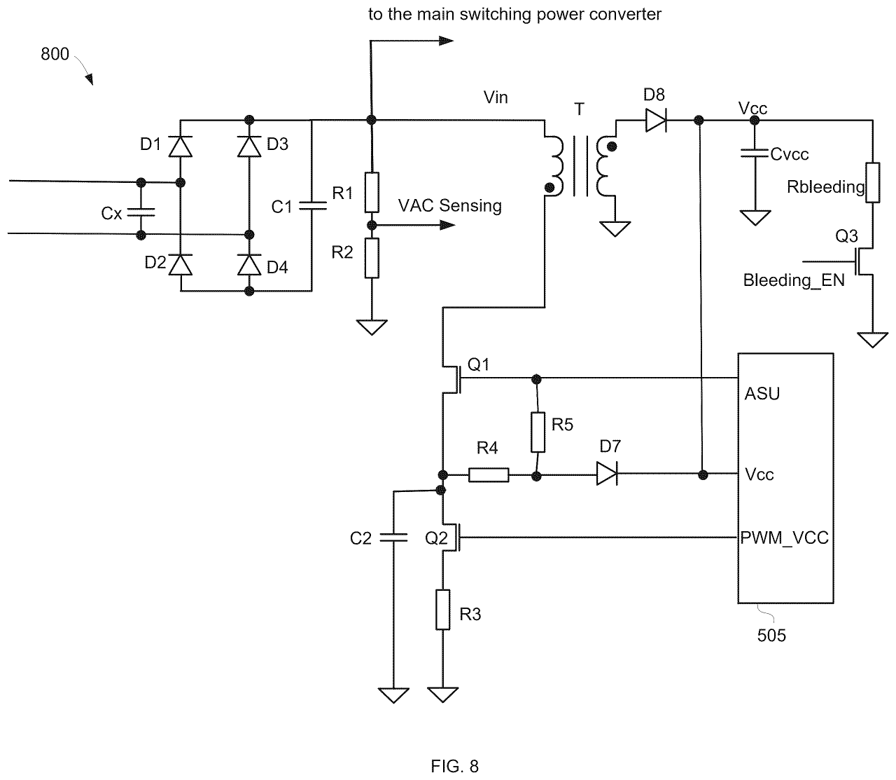

A post-bridge system 800 is shown in more detail in FIG. 8. The VAC sensing, diode bridge, and X capacitor are arranged as discussed for system 400 of FIG. 4. The input voltage Vin at the positive plate of the post-bridge capacitor C1 couples to the primary winding of the transformer T. The remainder of system 800 including the transistors Q1 and Q2, the resistors R3, R4, and R5, the capacitor C2, the diodes D7 and D8, the secondary winding, the controller IC 505, the capacitor CVccc, the bleeder resistor Rbleeding, and the bleeder transistor Q3 are arranged as discussed for system 500. The start-up current path, the charging current paths while transistor Q2 is cycled on and off, and the X capacitor discharging paths will thus be analogous except that the current to the primary winding must flow through the diode bridge into the node for the input voltage Vin. In system 800, the VCC charging circuit would thus be formed by the transformer T, transistors Q1, Q2 and Q3, resistors R3, R4, R5 and Rbleeding, diodes D7 and D8, and the capacitors C2 and CVcc.

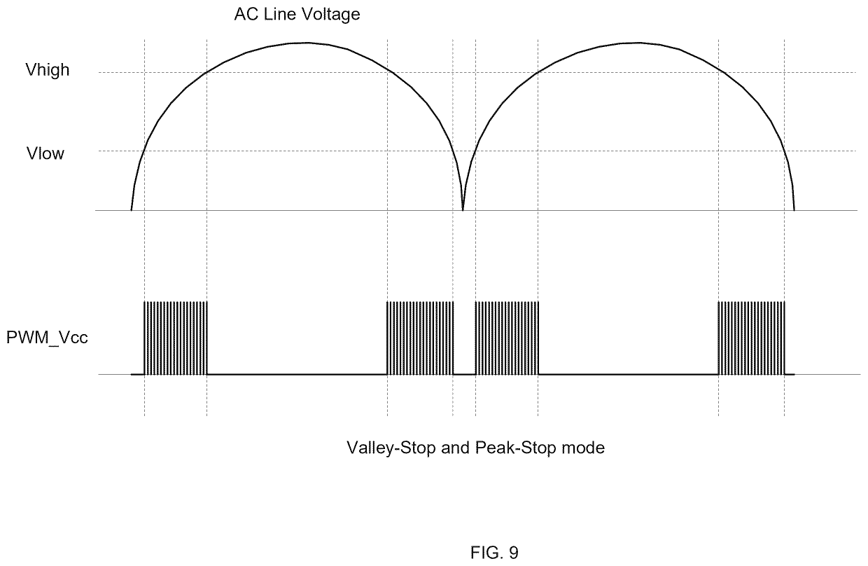

Regardless of whether a post-bridge or a pre-bridge coupling is used, the resulting knowledge of the AC input voltage waveform may be used to implement both a valley-stop mode and a peak-stop mode as shown in FIG. 9. In the valley-stop mode, the controller IC stops asserting the PWM_Vcc signal when the AC input voltage is deemed to have fallen before a threshold voltage Vlow. Note that at the trough (zero point) of the rectified AC input voltage waveform, the error signal between the power supply voltage Vcc and a desired level (Vref) of the power supply voltage Vcc is at a maximum. This error signal is used by the controller IC to determine the PWM_Vcc modulation signal such as through a constant on-time or a peak current control methodology. But since the error signal is directly proportional to the switching frequency of the transistor Q2, the switching frequency is also at a maximum as the AC line voltage nears its zero crossing point. Such an increase in switching frequency of the transistor Q2 can cause the system to transition from a discontinuous conduction mode to a continuous conduction mode. A discontinuous conduction mode is shown in the waveforms of FIG. 6 because the secondary current ramps down to zero (the end of the transformer reset period) before the transistor Q2 is again cycled on. But if the secondary current has not reached zero and the transistor Q2 cycles on, then the system has transitioned to the continuous conduction mode. Operation in the continuous conduction mode can cause undesirably high currents and sub-harmonic issues. But the controller ICs disclosed herein may respond to the AC line voltage dropping below the threshold voltage Vlow by de-asserting the PWM_Vcc modulation signal to prevent the transistor Q2 from cycling, thus avoiding the dangers of a transition to a continuous conduction mode of operation.

The controller ICs disclosed herein may also respond to the AC line voltage increasing above a threshold voltage Vhigh by again de-asserting the PWM_Vcc modulation signal to implement the peak-stop mode. The threshold voltage Vhigh is below the peak AC line voltage and sufficiently greater than the threshold voltage Vlow. By stopping the transistor Q2 from cycling when the AC line voltage increases above the threshold voltage Vhigh, the system avoids operation while the AC line voltage is excessively high. Should the transistor Q2 be cycled while the AC line voltage is near its peak value, the switching losses can be significant.

Utilizing the peak-stop mode thus increases efficiency, especially during lightload conditions. In addition, the drain-to-source voltage oscillations on the transistors Q1 when this transistor is cycled off with the AC line voltage near its peak value imposes additional stress, especially during heavy load conditions. To dampen such voltage oscillations, a snubber circuit may be used but the use of a snubber circuit lowers efficiency. The peak-stop mode thus reduces the voltage stress on the transistor Q1 without needing the use of a snubber circuit.

Those of some skill in this art will by now appreciate that many modifications, substitutions and variations can be made in and to the materials, apparatus, configurations and methods of use of the devices of the present disclosure without departing from the scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

1. A flyback converter for generating a power supply voltage of a controller integrated circuit for a main switching power converter, comprising:
a transformer including a primary winding and a secondary winding;
a first transistor having a drain coupled to the primary winding;
a power supply voltage capacitor having a positive terminal coupled to the secondary winding and having a negative terminal coupled to ground; and
a second transistor having a drain coupled to a source of the first transistor and having a source coupled to ground, wherein the controller integrated circuit includes a power supply voltage terminal coupled to the source of the first transistor and to the positive terminal of the power supply voltage capacitor.

2. The flyback converter of claim 1, further comprising
a first resistor; and
a first diode, wherein the power supply voltage terminal is coupled to the source drain of the first transistor through a serial combination of the first resistor and the first diode, and wherein the first resistor is connected between the source of the first transistor and an anode of the first diode, and wherein a cathode of the first diode is connected to the power supply voltage terminal.

3. The flyback converter of claim 2, further comprising:
a sense resistor connected between the source of the second transistor and ground; and
a second resistor coupled between a gate of the first transistor and the anode of the first diode, wherein an active start-up terminal of the controller integrated circuit is coupled to a gate of the first transistor.

4. The flyback converter of claim 1, wherein the first transistor is an n-type depletion-mode metal-oxide semiconductor field effect transistor.

5. The flyback converter of claim 4, wherein the second transistor is an n-type enhancement-mode metal-oxide semiconductor field effect transistor.

6. The flyback converter of claim 5, wherein the second transistor is integrated within the controller integrated circuit and wherein the first transistor is external to the controller integrated circuit.

7. The flyback converter of claim 3, wherein the controller integrated circuit includes a pulse width modulation signal terminal coupled to a gate of the second transistor.

8. The flyback converter of claim 3, further comprising:
a first capacitor coupled between the drain of the second transistor and ground.

9. The flyback converter of claim 1, further comprising:
a diode bridge for rectifying an AC input voltage into a rectified input voltage, wherein the main switching power converter is configured to convert the rectified input voltage into an output voltage responsive to a modulation signal from the controller integrated circuit.

10. The flyback converter of claim 9, further comprising:
a voltage divider coupled between a node for the rectified input voltage and ground, wherein the controller integrated circuit is further configured to sense the AC input voltage through the voltage divider.

11. A system comprising:
a diode bridge including a pair of input terminals and a pair of output terminals;
a main switching power converter coupled to the pair of output terminals and configured to convert a rectified input voltage into an output voltage;
a controller integrated circuit configured to provide a modulation signal to the main switching power converter to regulate the output voltage;
a first diode having an anode coupled to a positive input terminal from the pair of input terminals;
a second diode having an anode coupled to a negative input terminal from the pair of input terminals; and
a flyback converter including a transformer having a primary winding coupled to a cathode of the first diode and to a cathode of the second diode and having a secondary winding coupled to a power supply voltage capacitor configured to store a power supply voltage for the controller integrated circuit.

12. The system of claim 11, wherein the controller integrated circuit is further configured to modulate a cycling of a first transistor coupled between the primary winding and ground to regulate the power supply voltage.

13. The system of claim 12, further comprising:
a second transistor having a drain coupled to the primary winding and a source coupled to a drain of the first transistor, wherein the controller integrated circuit includes an active start-up terminal coupled to a gate of the second transistor.

14. The system of claim 13, wherein the first transistor is an enhancement-mode transistor and the second transistor is a depletion-mode transistor.

15. The system of claim 11, further comprising:
a resistive voltage divider coupled between ground and a node coupled to the cathode of the first diode and to the cathode of the second diode, wherein the controller integrated circuit is further configured to sense an AC input voltage through the resistive voltage divider.

16. A system comprising:
a diode bridge including a pair of input terminals and a pair of output terminals;
an input voltage capacitor coupled between the pair of output terminals;
a main switching power converter coupled to the pair of output terminals and configured to convert a rectified input voltage stored by the input voltage capacitor into an output voltage;
a controller integrated circuit configured to provide a modulation signal to the main switching power converter to regulate the output voltage; and
a flyback converter including a transformer having a primary winding having an input terminal coupled to a positive output terminal from the pair of output terminals and having a secondary winding coupled to a power supply voltage capacitor configured to store a power supply voltage for the controller integrated circuit.

17. The system of claim 16, further comprising:
a voltage divider coupled between the pair of output terminals, wherein the controller integrated circuit is further configured to sense an AC input voltage to the diode bridge through the voltage divider.

18. The system of claim 17, further comprising:
an X capacitor coupled between the pair of input terminals; and
a bleeder switch transistor coupled between the secondary winding and ground, wherein the controller integrated circuit is further configured to switch on the bleeder switch transistor to discharge the X capacitor in response to a sensing of the AC input voltage satisfying a threshold condition.

19. The system of claim 16, further comprising:
a first transistor having a drain coupled to the primary winding
a second transistor having a drain coupled to a source of the first transistor and having a source coupled to ground,
a first diode having a cathode coupled to a power supply voltage terminal of the controller integrated circuit and to the power supply voltage capacitor;
a first resistor coupled between the drain of the first transistor and an anode of the first diode; and
a second resistor coupled between the anode of the first diode and a gate of the first transistor, wherein the controller integrated circuit has an active start-up terminal coupled to the gate of the first transistor and has a pulse width modulation terminal coupled to a gate of the second transistor.

20. The system of claim 19, wherein the first transistor is a depletion-mode transistor and the second transistor is an enhancement-mode transistor.
